(19) United States
(12) Patent Application Publication
(10) Pub. No.: US 2003/0202110 A1
(43) Pub. Date: Oct. 30, 2003

(54) Arrangement of images

(76) Inventors: James W. Owens, Fort Collins, CO (US); James S. Voss, Fort Collins, CO (US); Robert Cazier, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/137,486

(22) Filed: Apr. 30, 2002

(51) Int. Cl. H04N 5/228

(52) U.S. Cl. 348/222.1

(57) ABSTRACT

Video, or sequences of still images, are presented in one or more areas of an arrangement, and within each area, images within the video or sequences of still images are selected for printing or display. Still images and portions of video may optionally be designated as of particular interest, and only images of particular interest are then presented.

### FIELD OF INVENTION

This invention relates generally to digital imaging and more specifically to creating arrangements of digital images.

### BACKGROUND OF THE INVENTION

Software for editing and manipulation of digital still images may be used to create arrangements (also called compositions, montages, or collages) of images. However, selecting, arranging, and editing images for arrangements is presently a labor and time intensive task. Availability of digital video adds substantially to the amount of data that must be manually reviewed and manipulated to create an arrangement of images. There is a need for additional computer assistance in creating arrangements of images, particularly from digital video.

### SUMMARY OF THE INVENTION

In an example embodiment, videos, or sequences of still images, are presented in one or more areas of an arrangement, and within each area, images within the videos or sequences of still images are selected for printing or display.

### BRIEF DESCRIPTION OF THE DRAWINGS

FIG. 1 illustrates an example of a photographic arrangement suitable for use with various example embodiments of the invention.

FIGS. 2A, 2B, 2C, and 2D illustrate examples of an alternative photographic arrangement for use with various example embodiments of the invention.

FIG. 3 is a flow chart illustrating example embodiments of multiple alternative methods in accordance with the invention.

### DETAILED DESCRIPTION OF THE PREFERRED EMBODIMENT OF THE INVENTION

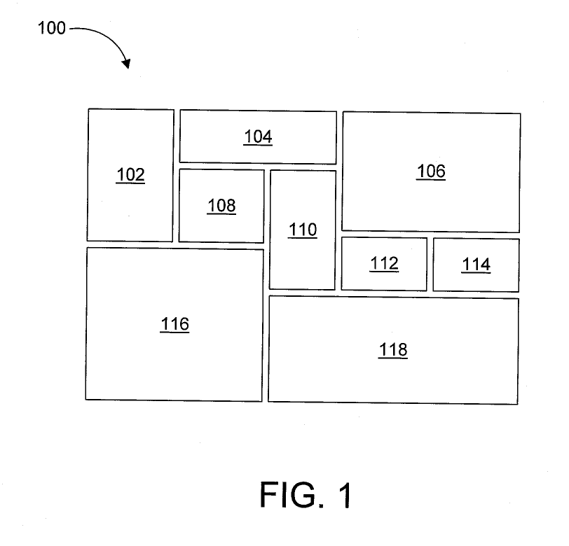

FIG. 1 illustrates an example of a photographic arrangement, or composition, or montage, 100. In the example arrangement, nine images of various sizes are arranged into an overall rectangular layout. Each image is printed or displayed within one of nine rectangular areas (102-118).

In the following discussion, first, a simplified example is used to provide an introduction, illustrating a few alternative methods for selection of images to be placed into the arrangement of FIG. 1, in accordance with the invention. After the introductory example, some overview and definitions are provided. Then, additional detail and additional alternatives and variations are discussed.

For an introductory example, the arrangement of FIG. 1 is displayed. No images are displayed initially, but the areas where images will be placed are visibly distinct. A human operator selects area 102 of the arrangement of FIG. 1, selects an earlier recorded digital video, and directs software to play the video in area 102. In the example, the video is viewed in the context of the overall arrangement. The human operator directs the software to pause the video at an image of interest, and to reverse and forward through a few still images from the video until the human operator selects a still image from the video for area 102. The human operator directs the software to zoom in on a particular part of the selected image, and to make the image slightly lighter. The scaled, translated, and edited still image is displayed in area 102.

The human operator then selects area 106, and selects a file containing a set of still images. The software sequentially presents the still images one at a time, with the operator selecting when to change to the next image. The operator selects a still image for area 106, and then zooms to a particular portion, and adjusts the color. The scaled, translated, and edited still image is displayed in area 106.

The operator then selects area 104, and directs the software to only present images in area 104 that have been previously identified as being appropriate for a horizontally oriented area. The software then presents a sequence of still images in area 104 that are particularly appropriate for the orientation of area 104. The operator selects an image for area 104, and edits the image as appropriate.

Finally, the operator selects all the remaining areas, and directs the software to randomly fill the remaining areas with still images that were previously identified as being of particular interest for an arrangement. The operator views the randomly selected images, selects area 110, and directs the software to present a different randomly selected image. When the operator is satisfied with the selection of images in each of the areas, the arrangement is printed.

The number of areas, the shape of the areas, and the arrangement of areas depicted in FIG. 1 are for purposes of illustration only. In general, the number of areas may be any number greater than one, the areas may be identically sized or differently sized, the areas may be other than rectangularly shaped, the overall arrangement may be other than rectangularly shaped, and the areas may overlap. Two or more areas may contain different portions of one overall image. The arrangement of areas may be pre-defined, or the operator preferably may specify an arrangement of areas. For a photographic arrangement that is displayed, the images within areas may comprise a sequence of images and may include videos, and the arrangement may vary over time. Areas may be selected in any order, and previously selected areas may be re-selected.

A video may be viewed as a temporal sequence of still images. In the following discussion, a sequence of images may be, for example, digital video, or may be a sequence of still images from a digital video (which may be a subset of a video, for example, every Nth frame, or frames representative of segments of a video, as discussed further below), or may be a series of images from a still-image digital camera, or may be a series of scanned images, or any combination of these. Video may be shown at a standard video rate (typically at least 30 images per second), or at a higher rate to reduce time to get to an area of interest, or at a slower rate to facilitate pausing on a particular frame. A sequence of images may be presented at regular intervals (for example, intervals of a few seconds), or may be presented one at a time with an operator controlling when the next image is displayed.

There are multiple standard formats and proprietary formats for compressed digital video. In general, for each format, each still image or video frame can be extracted, although some images may require more computation than others. For example, one common set of standards is from the Moving Pictures Expert Group (MPEG). In MPEG, each still image is called a picture, and sequences of pictures are grouped into sets of pictures called a Group of Pictures (GOP). Within a GOP, one picture, called an Intra-frame or I-frame, is compressed using only intraframe compression; that is, no information from other pictures is required. The other pictures within a GOP are compressed by specifying differences relative to adjacent pictures. Accordingly, within each GOP, one still image (the I-frame) can be extracted by decompressing a single picture, and other images can be extracted by starting with the I-frame and sequentially using the differencing information. A sequence of still images from video may comprise just I-frames.

Some digital image processing software can automatically partition a video into segments, where segment boundaries are defined by changes in content. Segment boundaries are also referred to as scene changes or scene boundaries. For example, if MPEG Discrete Cosine Transform coefficients change substantially for one frame relative to an adjacent frame, then a scene change may be indicated. Color changes may also used to provide an indication of a scene change. One frame, called a “key” frame or a “reference frame” may be selected from each segment as a still image that provides a visual indication of the contents of the corresponding segment. U.S. Pat. Nos. 5,635,982, 5,606,655, and 5,179,449 provide examples of detecting scene changes and selecting representative frames from each segment. A sequence of stills from video may comprise key frames or reference frames or other frames representative of video segments.

In one example embodiment of the invention, a sequence of images is presented within one or more selected areas. An operator can preferably pause, reverse, or play forward the sequence, searching for a suitable still image or sequence of images to use in each area. Each image or sequence of images may be viewed in a full-screen mode, or in a full-screen frame having the form factor of a selected area of an arrangement, or in a full-screen mode with a superimposed frame having the form factor of a selected area. Alternatively, the operator can view the sequence of images in the context of the shape of an individual area, and in relation to surrounding areas and images.

In the example arrangement illustrated in FIG. 1, a sequence of images may be presented within, for example, area 106. The operator is preferably provided with a control that can control the presentation speed, and can pause the video or sequence so that a single image is presented within area 106 for consideration. The operator is also preferably provided with the ability to reverse the sequence to review an image presented earlier, to zoom in or out so that area 106 includes an entire image or only a part of an image, and to pan, so that if only a part of an image is displayed, then effectively the part being displayed can be moved around on the entire image. Image processing, including for example contrast enhancement, reduction of blurring, gamma compensation, and color adjustment, and auto-cropping may be performed on a selected image.

Once an image or sequence of images for one area is selected, other sequences of images may then be presented within one or more of the other areas of the arrangement until still images or sequences of images have been selected and processed (scaled, translated, and enhanced) for all areas of the arrangement for printing or display.

A sequence of still images from video may be presented in temporal order or random order in each area. Alternatively, software may present a set of still images in a random or other non-temporal order within one area. Alternatively, software may fill all the areas of an arrangement with randomly selected images placed into each area. The operator may then select an area and request a different random selection, or may request to play a sequence of images forward or backward (temporal or some other file order) from the random selection.

The time required to create an arrangement may be further reduced by preprocessing the video and still images, and identifying video portions of particular interest and still images of particular interest, or video portions and still images of particular interest and suitability. Suitability includes, for example, suitability for form factor (e.g., square, round, rectangular), suitability for size (e.g., large, small), and suitability for orientation (e.g., vertical, horizontal). For example, given a method to identify images and sequences of images as particularly interesting and particularly suitable for horizontal orientation, the software may be instructed to present only those identified images and sequences of images within each horizontally oriented area during creation of an arrangement. This may substantially reduce the time required to select all the images for the arrangement.

For example, within a set of videos of a vacation in Italy, the operator may tag, among others, a portion of a video of canal boats in Venice to be of particular interest, may tag a portion of a video of the leaning tower of Pisa to be of particular interest and particularly suitable for vertical presentation, and may tag a portion of a video of a bridge in Florence to be of particular interest and particularly suitable for horizontal presentation. Then, using the example arrangement of FIG. 1, when the operator is selecting images for the arrangement, the video of the bridge in Florence will be presented only in horizontally oriented areas (104, 106, 108, 112, 114, and 118), the video of the leaning tower of Pisa will be presented only in vertically oriented areas (102, 110), and the video of canal boats in Venice will be presented in all areas. The operator may request to see only portions of videos that have been tagged as being of particular interest, and portions that have not been so tagged will not be presented during composition of the arrangement.

There are multiple standards for attaching miscellaneous data (metadata) to digital video and to digital still images. MPEG-7 (ISO/IEC 15938) includes a provision for attaching metadata (Multimedia Description Schemes or MDS) used for searching multimedia collections and defining relationships among multimedia objects. In particular, there are MDS categories for user interaction. Exchangeable Image File (EXIF) format is a Japan Electronic Industry Development Association (JEIDA) standard used by many existing digital cameras, and includes a provision for storing metadata at the beginning of image files. The Digital Imaging Group standard (DIG-35) extends EXIF and will be used by many digital cameras. The Synchronized Multimedia Integration Language (SMIL) is a standard for interactive presentations. Any of these may accommodate tags or data to indicate that an image or sequence of images is intended to be included in an arrangement, or is of particular interest for inclusion in an arrangement, or is particularly suitable for areas having a particular form factor, size, or orientation.

Selection of images to be included in an arrangement, and tagging of images as being of particular interest, may be performed in a camera. Commercially available digital cameras can take both digital still images and digital video. These cameras commonly include a display that can be used to view videos and still images stored in the camera's memory. In accordance with an example embodiment of the invention, a camera operator, during playback of a video in a camera, may select the beginning and end points of portions of a video, designating the portions as being of particular interest (and if appropriate, of particular suitability for a given size, form factor, or orientation). Likewise, the camera may present a sequence of still images from its memory, and the operator may specify that an image is be included in an arrangement, or may designate an image as being of particular interest for an arrangement (and if appropriate, of particular suitability for a given form factor, size, or orientation).

For the alternative in which software presents random still images for consideration, the random still images may be selected from portions of videos tagged as being of particular interest and tagged as being particularly suitable for a given form factor, size, or orientation. For example, using the images from Italy, for horizontally oriented area 104, the random images would be selected from identified portions of the video of a bridge in Florence and from identified portions of the video of canal boats in Venice. For vertically oriented area 102, the random images would be selected from identified portions of the video of the leaning tower of Pisa and from identified portions of the video of canal boats in Venice.

The final arrangement may comprise an arrangement of areas in a display in which the images vary—that is, video data or a sequence of still images is presented instead of only a still image in each area. Each area, or a subset of the areas, may display a selected video sequence, or a selected sequence of still images. In addition, for an arrangement that is to be displayed, the arrangement itself may be dynamic.

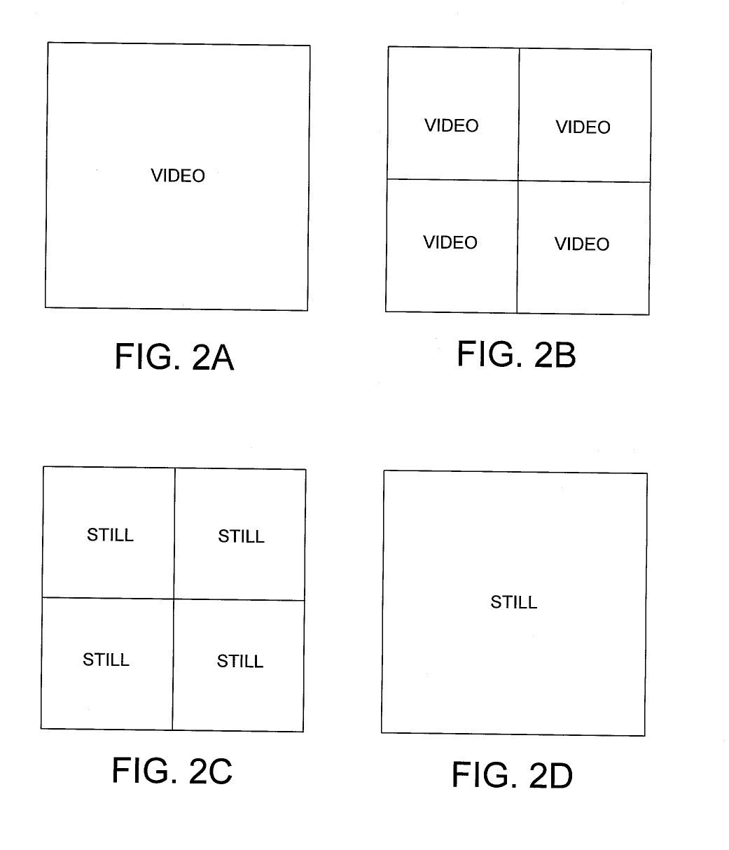

FIGS. 2A through 2D depict one example of a dynamic arrangement for a display. FIG. 2A depicts a display in which the entire display area is filled by a single video. This single video may then transition to four separate videos, as depicted in FIG. 2B. These may transition to a temporary display of four separate still images, as depicted in FIG. 2C. Finally, the entire display may then be temporarily filled with a still image, as depicted in FIG. 2D. For purposes of example only, a video of a sporting event may be displayed as in FIG. 2A, with a transition to four separate videos of four separate players in FIG. 2B, with a transition to four separate still images of four separate players in FIG. 2C, with a transition to a still image of one player in FIG. 2D. A dynamic arrangement could, of course, have mixed stills and video.

A dynamic arrangement with multiple simultaneous videos may be composed one frame at a time as a non-real-time process. That is, given a selection of videos, the first frame of each video may be assembled into the first frame of the arrangement, the second frame of each video may be assembled into the second frame of the arrangement, and so forth. The resulting frames of the arrangement may then the compressed as a digital video for real-time replay. Alternatively, multiple decoding channels may be implemented to decode multiple digital videos simultaneously in real time, with a processor used to assemble the resulting decoded video frames into the arrangement in real time. A high level descriptor language such as SMIL may be used to open separate execution threads to call decoders and to size and place the videos on the display.

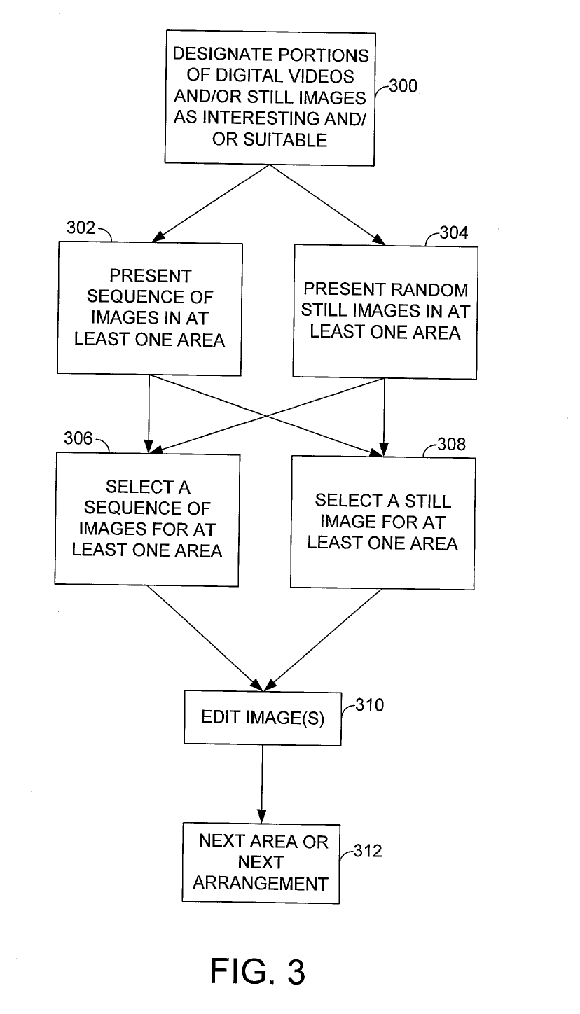

FIG. 3 is a flow chart illustrating multiple example alternative methods as discussed above. At step 300, which is optional, portions of videos and various still images may be designated as of particular interest and various portions of videos or still images may be designated as of particular interest and particularly suitable for areas having a particular size, form factor, or orientation.

Steps 302 and 304 depict two alternatives, which may be mixed during the creation of an arrangement. For the alternative depicted in step 302, a sequence of images (video, sequence of stills from video, sequence of stills other than video) is presented in at least one area (one sequence may be presented in one area, one sequence may be presented simultaneously in multiple areas, or different sequences may be presented simultaneously in multiple areas). For the alternative depicted in step 304, still images are randomly presented (preferably, a different image is presented in each of the available areas simultaneously, but images could be presented randomly in just one area or a subset of the areas).

Steps 306 and 308 represent two alternatives for selection of images to be printed or displayed, and these alternatives may be mixed in any manner for any one arrangement, or may be mixed over time for a dynamic arrangement. For the alternative depicted by step 306, a sequence of images (video, portion of video, sequence of stills from video, sequence of stills other than video) is selected for at least one area (one sequence may be selected for one area, one sequence may be selected for multiple areas, or different sequences may be selected for multiple areas, or multiple sequences may be selected for one area). For the alternative depicted by step 308, a still image is selected for at least one area. Note that for alternative 306, the entire arrangement is displayed as opposed to being printed, but even for a display alternative, some areas may have sequences of images and other areas may have only still images.

At step 310, which is optional, selected still images or sequences of images may be edited by scaling, sharpening, adjusting color, auto-cropping, etc. At step 312, if there are areas that do not have a selection, then another area is selected and the process of FIG. 3 is repeated. Alternatively, at step 312, if the arrangement is to change over time, then another arrangement is selected and the process of FIG. 3 is repeated.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of creating an arrangement of images, comprising:
selecting at least one first area within an arrangement of a plurality of areas;
selecting at least one first image for the first area;
selecting at least one second area within the arrangement of the plurality of areas;
presenting a sequence of images in at least the second area; and selecting at least a portion of the sequence of images for the second area.

2. The method of claim 1, further comprising:
the sequence of images comprising a digital video.

3. The method of claim 1, further comprising:
the sequence of images comprising a sequence of still images from a digital video.

4. The method of claim 1, further comprising:
the sequence of images comprising a sequence of still images.

5. The method of claim 1, further comprising:
the sequence of images comprising random selections of still images from a digital video.

6. The method of claim 1, further comprising:
the sequence of images comprising random selections of still images.

7. The method of claim 1, further comprising:
selecting the sequence of images from at least a portion of a digital video, the portion having been previously designated as being of particular interest.

8. The method of claim 1, further comprising:
selecting the sequence of images from images that have been previously designated as being suitable for an area having a particular orientation.

9. The method of claim 8, further comprising:
selecting the sequence of images from images that have been previously designated as being suitable for an area having a vertical orientation.

10. The method of claim 8, further comprising:
selecting the sequence of images from images that have been previously designated as being suitable for an area having a horizontal orientation.

11. The method of claim 1, further comprising:
selecting the sequence of images from images that have been previously designated as being suitable for an area having a particular form factor.

12. The method of claim 1, further comprising:
selecting the sequence of images from images that have been previously designated as being suitable for an area having a particular size.

13. The method of claim 1, the at least a portion of the sequence of images further comprising a still image.

14. The method of claim 13, further comprising:
zooming the still image within the second area, so that less than the entire still image is presented within the second area.

15. The method of claim 14, further comprising:
translating the still image relative to the second area, so that different portions of the still image are visible within the second area.

16. The method of claim 1, the at least a portion of the sequence of images further comprising a video.

17. The method of claim 1, the at least a portion of the sequence of images further comprising a sequence of still images from video.

18. The method of claim 1, the at least a portion of the sequence of images further comprising a sequence of still images.

19. The method of claim 1, the sequence of images comprising a first sequence of images, the method further comprising:
presenting a second sequence of images in at least the second area;
selecting at least a portion of the second sequence of images for the second area, to be displayed at a different time than the at least a portion of the first sequence of images.

20. A method, comprising:
presenting a sequence of images on a display; and
designating at least one image in the sequence of images as being intended for an arrangement of images.

21. A method, comprising:
presenting a sequence of images on a display; and
designating at least one image in the sequence of images as being of particular interest for an arrangement of images.

22. The method of claim 21, further comprising:
designating, at least one image that has been designated as being of particular interest for an arrangement of images, as being suitable for an area having a particular size.

23. The method of claim 21, further comprising:
designating, at least one image that has been designated as being of particular interest for an arrangement of images, as being suitable for an area having a particular form factor.

24. The method of claim 21, further comprising:
designating, at least one image that has been designated as being of particular interest for an arrangement of images, as being suitable for an area having a particular orientation.

25. A camera, programmed to perform the following method:
presenting a sequence of images on a display; and
designating at least one image in the sequence of images as being intended for an arrangement of images.

26. A camera, programmed to perform the following method:
presenting a sequence of images on a display; and
designating at least one image in the sequence of images as being of particular interest for an arrangement of images.

27. The camera of claim 26, further programmed to perform the following method:
designating, at least one image that has been designated as being of particular interest for an arrangement of images, as being suitable for an area having a particular size.

28. The camera of claim 26, further programmed to perform the following method:
designating, at least one image that has been designated as being of particular interest for an arrangement of images, as being suitable for an area having a particular form factor.

29. The camera of claim 26, further programmed to perform the following method:
designating, at least one image that has been designated as being of particular interest for an arrangement of images, as being suitable for an area having a particular orientation.

30. A computer, programmed to perform the following method:
receiving a selection of at least one first area within an arrangement of a plurality of areas;
receiving a selection of at least one first image for the first area; displaying the first image in the first area;
receiving a selection of at least one second area within the arrangement of the plurality of areas;
presenting a sequence of images in at least the second area;
receiving a selection of at least a portion of the sequence of images for the second area; and
displaying the at least a portion of the sequence of images in the second area.

31. A memory medium, readable by a computer, containing software code for performing the following method:
receiving a selection of at least one first area within an arrangement of a plurality of areas;
receiving a selection of at least one first image for the first area;
displaying the first image in the first area;
receiving a selection of at least one second area within the arrangement of the plurality of areas;
presenting a sequence of images in at least the second area;
receiving a selection of at least a portion of the sequence of images for the second area; and
displaying the at least a portion of the sequence of images in the second area.
